(19) United States
(12) Patent Application Publication
(10) Pub. No.: US 2025/0391338 A1
(43) Pub. Date: Dec. 25, 2025

(54) SUB PIXEL, AND ELECTRONIC DEVICE

(71) Applicants: Samsung Display Co., Ltd., Yongin-si (KR); IUCF-HYU (Industry-University Cooperation Foundation Hanyang University), Seoul (KR)

(72) Inventors: Byung Chang YU, Yongin-si (KR); Kyung Hoon CHUNG, Yongin-si (KR); Oh Kyong KWON, Seoul (KR); Youn Sik KIM, Seoul (KR); Sung Min WEE, Seoul (KR)

(21) Appl. No.: 19/207,272

(22) Filed: May 13, 2025

(30) Foreign Application Priority Data
Jun. 21, 2024 (KR) 10-2024-0081213
Aug. 8, 2024 (KR) 10-2024-0106039

(51) Int. Cl. G09G 3/32

(52) U.S. Cl. CPC G09G 3/32; G09G 2300/0819; G09G 2310/066; G09G 2310/08; G09G 2320/064

(57) ABSTRACT

A sub-pixel includes a light-emitting element configured to receive a driving current, and to emit light, a first transistor configured to generate the driving current, a second transistor configured to transmit the driving current to the light-emitting element in response to a signal from a first node, a third transistor configured to provide a first power voltage to the first node in response to a signal from a second node, a fourth transistor configured to provide a data voltage to the second node in response to a scan signal, and a first capacitor including a first electrode for receiving a ramp signal, and a second electrode connected to the second node.

### CROSS-REFERENCE TO RELATED APPLICATION

The present application claims priority to, and the benefit of, Korean Patent Application No. 10-2024-0081213, filed on Jun. 21, 2024, and Korean Patent Application No. 10-2024-0106039, filed on Aug. 8, 2024, in the Korean Intellectual Property Office, the entire disclosures of which are incorporated herein by reference.

### BACKGROUND

### 1. Field

Embodiments of the present disclosure relate to a sub-pixel, and electronic device.

### 2. Description of the Related Art

As information technology develops, the importance of display devices, which are a connecting medium between users and information, is increasing. Accordingly, the use of display devices such as liquid crystal display devices, organic light-emitting display devices, and inorganic light-emitting display devices is increasing.

Recently, research on micro LEDs, which have a faster response speed and can implement high brightness compared to conventional LEDs, is being actively conducted. In the case of inorganic light-emitting elements such as micro LEDs, when using a pulse amplitude modulation (PAM) pixel driving method like an organic light-emitting element (organic LED), it may be difficult to accurately implement the desired brightness because the center wavelength of the current shifts depending on the current density. Therefore, in the case of micro LEDs, a pulse width modulation (PWM) pixel driving method that expresses brightness by controlling the time that current flows to the light-emitting element can be used.

### SUMMARY

One aspect of the present disclosure provides a sub-pixel driven by a PWM method.

Another aspect of the present disclosure provides a display device including a sub-pixel.

A sub-pixel according to embodiments of the present disclosure includes a light-emitting element configured to receive a driving current, and to emit light, a first transistor configured to generate the driving current, a second transistor configured to transmit the driving current to the light-emitting element in response to a signal from a first node, a third transistor configured to provide a first power voltage to the first node in response to a signal from a second node, a fourth transistor configured to provide a data voltage to the second node in response to a scan signal, and a first capacitor including a first electrode for receiving a ramp signal, and a second electrode connected to the second node.

The sub-pixel may further include a second capacitor including a first electrode for receiving an initialization voltage, and a second electrode connected to the first node.

The first power voltage may have a first driving voltage in a non-emitting period of one frame, and a second driving voltage that is higher than the first driving voltage in an emitting period of the one frame.

The non-emitting period may include an initialization period in which the second capacitor is initialized, and a writing period in which the data voltage is written to the first capacitor.

The scan signal may have an activation level in the writing period.

The ramp signal may be lowered to a first ramp voltage when the initialization period starts.

The ramp signal may have a second ramp voltage that is higher than the first ramp voltage in the writing period.

The non-emitting period may further include a holding period in which the ramp signal increases from the second ramp voltage to a third ramp voltage that is higher than the second ramp voltage.

The ramp signal may decrease in the emitting period.

The scan signal has a waveform of a driving frequency, and the first power voltage and the ramp signal have a waveform of a reference frequency.

A sub-pixel according to embodiments of the present disclosure may include a light-emitting element configured to receive a driving current, and to emit light, a first transistor configured to generate the driving current, a second transistor configured to transmit a second power voltage to the first transistor in response to a signal from a first node, a third transistor configured to provide the second power voltage to the first node in response to a signal from a second node, a fourth transistor configured to provide a data voltage to the second node in response to a scan signal, and a first capacitor including a first electrode for receiving a ramp signal, and a second electrode connected to the second node.

The sub-pixel may further include a second capacitor including a first electrode for receiving an initialization voltage, and a second electrode connected to the first node.

The second power voltage may have a first driving voltage in a non-emitting period of one frame, and a third driving voltage that is lower than the first driving voltage in an emitting period of the one frame.

The non-emitting period may include an initialization period in which the second capacitor is initialized, and a writing period in which the data voltage is written to the first capacitor.

The scan signal may have an activation level in the writing period.

The ramp signal may be raised to a fourth ramp voltage when the initialization period starts.

The ramp signal may have a third ramp voltage that is lower than the fourth ramp voltage in the writing period.

The non-emitting period may further include a holding period in which the ramp signal is lowered from the third ramp voltage to a second ramp voltage that is lower than the third ramp voltage.

The ramp signal may increase in the emitting period.

An electronic device according to embodiments of the present disclosure may include a display device including a display panel including a sub-pixel, and a display panel driver configured to drive the display panel, wherein the sub-pixel includes a light-emitting element configured to receive a driving current, and to emit light, a first transistor configured to generate the driving current, a second transistor configured to transmit the driving current to the light-emitting element in response to a signal from a first node, a third transistor configured to provide a first power voltage to the first node in response to a signal from a second node, a fourth transistor configured to provide a data voltage to the second node in response to a scan signal, and a first capacitor including a first electrode for receiving a ramp signal, and a second electrode connected to the second node.

### BRIEF DESCRIPTION OF THE DRAWINGS

FIG. 1 is a block diagram illustrating a display device according to embodiments of the present disclosure.

FIG. 2 is a plan view illustrating one or more embodiments of a display panel of FIG. 1.

FIG. 3 is a cross-sectional diagram illustrating one or more embodiments of the display panel of FIG. 2.

FIG. 4 is a cross-sectional diagram illustrating one or more other embodiments of the display panel of FIG. 2.

FIG. 5 is a circuit diagram illustrating an example of a sub-pixel of FIG. 1.

FIG. 6 is a conceptual diagram for explaining a driving operation of the display device of FIG. 1.

FIG. 7 is a timing diagram illustrating an example in which the display device of FIG. 1 performs a display scan operation.

FIGS. 8 and 9 are diagrams for explaining an initialization period of FIG. 7.

FIGS. 10 and 11 are diagrams for explaining a writing period of FIG. 7.

FIGS. 12 and 13 are diagrams for explaining a holding period of FIG. 7.

FIGS. 14 to 16 are diagrams for explaining an emitting period of FIG. 7.

FIG. 17 is a timing diagram illustrating an example of a voltage of a first node, a voltage of a second node, and a driving current in a frame in which a display scan operation of FIG. 6 is performed.

FIG. 18 is a timing diagram illustrating an example in which the display device of FIG. 1 performs a self-scan operation.

FIG. 19 is a timing diagram illustrating an example in which the display device of FIG. 1 performs a display scan operation and a self-scan operation.

FIG. 20 is a circuit diagram illustrating a sub-pixel of a display device according to embodiments of the present disclosure.

FIG. 21 is a timing diagram illustrating an example in which the display device of FIG. 20 performs a display scan operation.

FIG. 22 is a timing diagram illustrating an example in which the display device of FIG. 20 performs a self-scan operation.

FIG. 23 is a block diagram illustrating one or more embodiments of a display system.

FIGS. 24 to 27 are perspective views illustrating application examples of the display system of FIG. 23.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

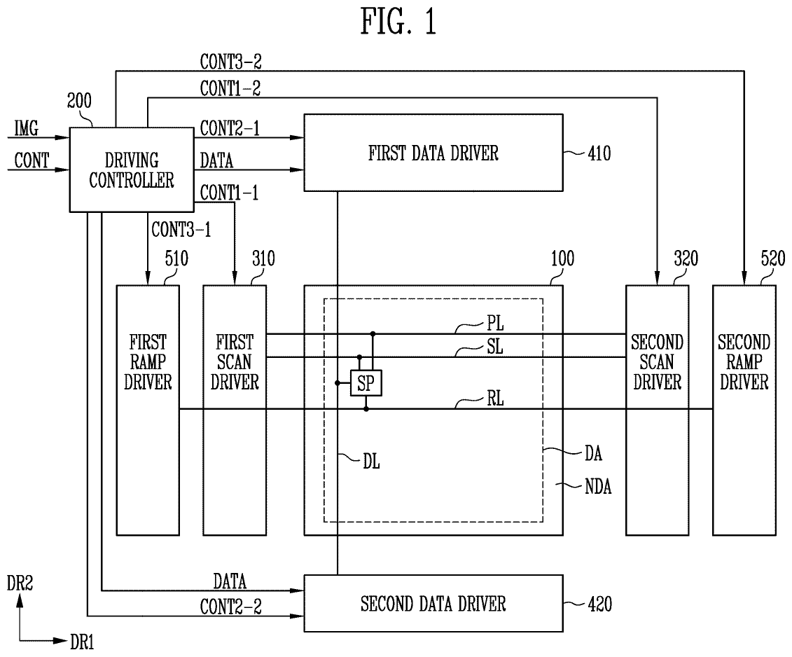

FIG. 1 is a block diagram illustrating a display device according to embodiments of the present disclosure.

Referring to FIG. 1, the display device may include a display panel 100 and a display panel driver. The display panel driver may include a driving controller 200, a first scan driver 310, a second scan driver 320, a first data driver 410, a second data driver 420, a first ramp driver 510, and a second ramp driver 520. In one or more embodiments, the driving controller 200, the first and second data drivers 410, 420 may be integrated into one chip.

The display panel 100 may include a display area (DA) for displaying an image and a non-display area (NDA) arranged adjacent to the display area (DA). In one or more embodiments, at least one of the first and/or second scan drivers 310, 320 and/or the first and/or second ramp drivers 510, 520 may be mounted in the non-display area (NDA).

The display panel 100 may include a plurality of scan lines (SL), a plurality of power lines (PL), a plurality of data lines (DL), a plurality of ramp lines (RL), and a plurality of sub-pixels (SP) electrically connected to the scan lines (SL), the power lines (PL), the data lines (DL), and the ramp lines (RL). The scan lines (SL), the power lines (PL), and the ramp lines (RL) may extend in a first direction (DR1), and the data lines (DL) may extend in a second direction (DR2) crossing the first direction (DR1).

The driving controller 200 may receive input image data (IMG) and an input control signal (CONT) from a main processor (e.g., a graphic processing unit (GPU) or the like). For example, the input image data (IMG) may include red image data, green image data, and blue image data. In one or more embodiments, the input image data (IMG) may further include white image data. For another example, the input image data (IMG) may include magenta image data, yellow image data, and cyan image data. The input control signal (CONT) may include a master clock signal and a data enable signal. The input control signal (CONT) may further include a vertical synchronization signal and a horizontal synchronization signal.

The driving controller 200 may generate a first-first control signal (CONT1-1), a first-second control signal (CONT1-2), a second-first control signal (CONT2-1), a second-second control signal (CONT2-2), a third-first control signal (CONT3-1), a third-second control signal (CONT3-2), and a data signal (DATA) based on the input image data (IMG) and the input control signal (CONT).

The driving controller 200 may generate the first-first control signal (CONT1-1) for controlling an operation of the first scan driver 310 based on the input control signal (CONT), and may output it to the first scan driver 310. The driving controller 200 may generate the first-second control signal (CONT1-2) for controlling the operation of the second scan driver 320 based on the input control signal (CONT), and may output it to the second scan driver 320. The first-first and first-second control signals (CONT1-1, CONT1-2) may include a vertical start signal and a gate clock signal.

The driving controller 200 may generate the second-first control signal (CONT2-1) for controlling the operation of the first data driver 410 based on the input control signal (CONT), and may output it to the first data driver 410. The driving controller 200 may generate the second-second control signal (CONT2-2) for controlling the operation of the second data driver 420 based on the input control signal (CONT), and may output it to the second data driver 420. The second-first and second-second control signals (CONT2-1, CONT2-2) may include a horizontal start signal and a load signal.

The driving controller 200 may generate the third-first control signal (CONT3-1) for controlling the operation of the first ramp driver 510 based on the input control signal (CONT), and may output it to the first ramp driver 510. The driving controller 200 may generate the third-second control signal (CONT3-2) for controlling the operation of the second ramp driver 520 based on the input control signal (CONT), and may output it to the second ramp driver 520. The third-first and third-second control signals (CONT3-1, CONT3-2) may include a vertical start signal.

The driving controller 200 may receive input image data (IMG) and the input control signal (CONT) to generate a data signal (DATA). The driving controller 200 may output the data signal (DATA) to the first and second data drivers 410, 420.

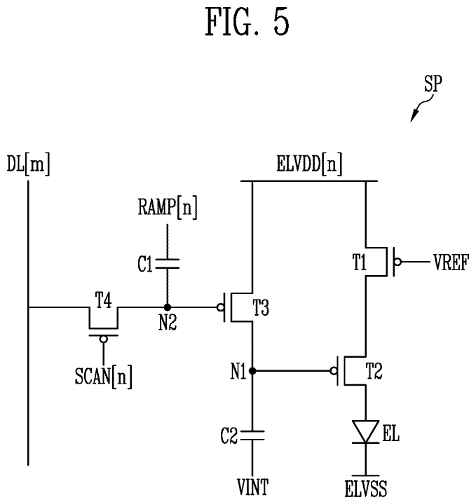

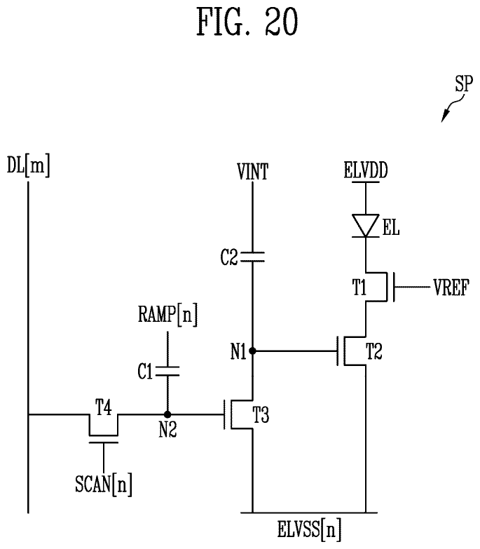

The first and second scan drivers 310, 320 may generate scan signals (SCAN[n], see FIG. 5) for driving scan lines (SL) and power signals (e.g., the first power voltage (ELVDD[n]) of FIG. 5 and the second power voltage (ELVSS[n]) of FIG. 20) for driving power lines (PL) in response to the first-first and first-second control signals (CONT1-1, CONT1-2) received from the driving controller 200. The first and second scan drivers 310, 320 may output scan signals to the scan lines (SL). The first and second scan drivers 310, 320 may output power signals to the power lines (PL). For example, the first and second scan drivers 310, 320 may sequentially output scan signals to the scan lines (SL), and may sequentially output power signals to the power lines (PL).

In one or more embodiments, the first scan driver 310 may provide scan signals and power signals to the first portion of the sub-pixels (SP), and the second scan driver 320 may provide scan signals and power signals to the second portion of the sub-pixels (SP) excluding the first portion. For example, the first scan driver 310 may provide scan signals and power signals to the sub-pixels (SP) of odd-numbered pixel rows, and the second scan driver 320 may provide scan signals and power signals to the sub-pixels (SP) of even-numbered pixel rows. However, the first portion and the second portion are not limited to the sub-pixels (SP) of odd-numbered pixel rows and the sub-pixels (SP) of even-numbered pixel rows.

The scan driver may be divided into the first scan driver 310 and the second scan driver 320, but the present disclosure is not limited thereto. For example, a single scan driver may provide scan signals and power signals to sub-pixels (SP).

The first and second scan drivers 310, 320 may provide scan signals and power signals, but the present disclosure is not limited thereto. For example, the first and second scan drivers 310, 320 may provide scan signals, and a configuration separate from the first and second scan drivers 310, 320 may provide power signals.

The first and second data drivers 410, 420 may receive the second-first and second-second control signals (CONT2-1, CONT2-2) and the data signal (DATA) from the driving controller 200. The first and second data drivers 410, 420 may generate data voltages by converting the data signal (DATA) into an analog voltage. The first and second data drivers 410, 420 may output the data voltages to the data line (DL).

In one or more embodiments, the first data driver 410 may provide data voltages to a first portion of the sub-pixels (SP), and the second data driver 420 may provide data voltages to a second portion of the sub-pixels (SP) excluding the first portion. For example, the first data driver 410 may provide data voltages to the sub-pixels (SP) of odd-numbered pixel columns, and the second data driver 420 may provide data voltages to the sub-pixels (SP) of even-numbered pixel columns. However, the first portion and the second portion are not limited to the sub-pixels (SP) of odd-numbered pixel columns and the sub-pixels (SP) of even-numbered pixel columns.

The data driver may be divided into the first data driver 410 and the second data driver 420, but the present disclosure is not limited thereto. For example, a single data driver may provide data voltages to the sub-pixels (SP).

The first and second ramp drivers 510, 520 may generate ramp signals (RAMP[n], see FIG. 5) for driving ramp lines (RL) in response to the third-first and third-second control signals (CONT3-1, CONT3-2) received from the driving controller 200. The first and second ramp drivers 510, 520 may output ramp signals to the ramp lines (RL). For example, the first and second ramp drivers 510, 520 may sequentially output ramp signals to the ramp lines (RL).

In one or more embodiments, the first ramp driver 510 may provide ramp signals to a first portion of sub-pixels (SP), and the second ramp driver 520 may provide ramp signals to a second portion of sub-pixels (SP) excluding the first portion.

For example, the first ramp driver 510 may provide ramp signals to the sub-pixels (SP) of odd-numbered pixel rows, and the second ramp driver 520 may provide ramp signals to the sub-pixels (SP) of even-numbered pixel rows. However, the first portion and the second portion are not limited to the sub-pixels (SP) of odd-numbered pixel rows and the sub-pixels (SP) of even-numbered pixel rows.

The ramp driver may be divided into the first ramp driver 510 and the second ramp driver 520, but the present disclosure is not limited thereto. For example, a single ramp driver may provide ramp signals to sub-pixels (SP).

The display device according to one or more embodiments is a device that displays a moving image and/or a still image. The display device may be applied to portable electronic devices such as mobile phones, smartphones, tablet personal computers (PCs), mobile communication terminals, electronic notebooks, electronic books, portable multimedia players (PMPs), navigations, and ultra-mobile PCs (UMPCs). For example, the display device may be applied to a display unit of a television, a laptop computer, a monitor, a billboard, or the Internet of Things (IoT). Alternatively, in one or more embodiments, the display device may be applied to a smartwatch, a watch phone, and/or a head-mounted display device (HMD) for implementing virtual reality and/or augmented reality.

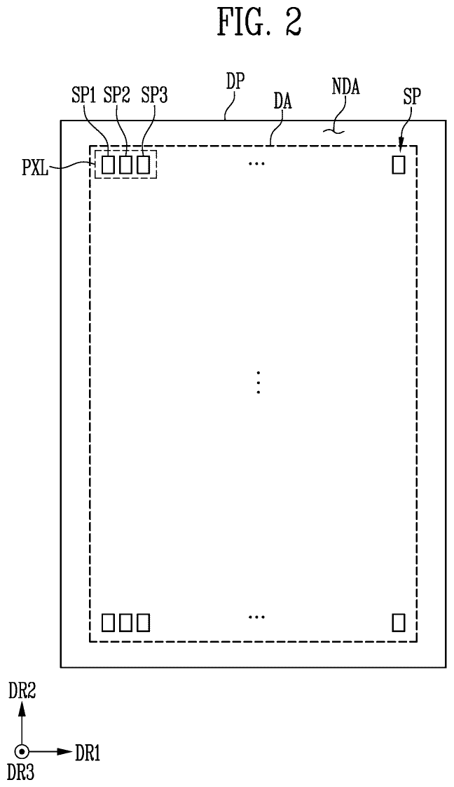

FIG. 2 is a plan view illustrating one or more embodiments of a display panel of FIG. 1.

Referring to FIG. 2, a display panel (DP) may include a display area (DA) and a non-display area (NDA). The display panel (DP) displays an image through the display area (DA). The non-display area (NDA) is arranged around the display area (DA).

The display panel (DP) includes sub-pixels (SP) in the display area (DA). The sub-pixels (SP) may be arranged along a first direction (DR1) and along a second direction (DR2) crossing the first direction (DR1). For example, the sub-pixels (SP) may be arranged in a matrix form along the first direction (DR1) and along the second direction (DR2). As another example, the sub-pixels (SP) may be arranged in a zigzag form along the first direction (DR1) and the second direction (DR2). The arrangement of the sub-pixels (SP) may vary depending on the embodiments. The first direction (DR1) may be a row direction, and the second direction (DR2) may be a column direction.

Among the plurality of sub-pixels (SP), two or more sub-pixels may constitute one pixel (PXL). In FIG. 2, the pixel (PXL) is illustrated as including three sub-pixels (SP1 to SP3), but the embodiments are not limited thereto. For example, the pixel (PXL) may include two sub-pixels. Hereinafter, for convenience of explanation, it is assumed that the pixel (PXL) includes first to third sub-pixels (SP1 to SP3).

Each of the first to third sub-pixels (SP1 to SP3) may generate light of one of various colors, such as red, green, blue, cyan, magenta, and yellow. Hereinafter, for clear and concise explanation, it is assumed that the first sub-pixel (SP1) is configured to generate light of red color, the second sub-pixel (SP2) is configured to generate light of green color, and the third sub-pixel (SP3) is configured to generate light of blue color.

Each of the first to third sub-pixels (SP1 to SP3) may include at least one light-emitting element configured to generate light. In embodiments, the light-emitting elements of the first to third sub-pixels (SP1 to SP3) may generate light of the same color. For example, the light-emitting elements of the first to third sub-pixels (SP1 to SP3) may generate light of blue color. In other embodiments, the light-emitting elements of the first to third sub-pixels (SP1 to SP3) may generate light of different colors. For example, the light-emitting elements of the first to third sub-pixels (SP1 to SP3) may generate light of red color, green color, and blue color, respectively.

As the display panel (DP), a self-luminous display panel, such as an LED display panel that uses micro-scale or nano-scale light-emitting diodes as light-emitting elements, an organic light-emitting display panel (OLED panel) that uses organic light-emitting diodes as light-emitting elements, etc., may be used.

In the non-display area (NDA), components for controlling sub-pixels (SP) may be arranged. Wires connected to the sub-pixels (SP), for example, the first to m^{th} gate lines (GL1 to GLm), the first to n^{th} data lines (DL1 to DLn), the power lines (PL), and the pixel control lines (PXCL) of FIG. 1, may be arranged in the non-display area (NDA).

At least one of the driving controller 200, the first and second scan drivers 310, 320, the first and second data drivers 410, 420, and the first and second ramp drivers 510, 520 of FIG. 1 may be arranged in the non-display area (NDA) of the display panel (DP). In embodiments, the first and second scan drivers 310, 320 and the first and second ramp drivers 510, 520 may be arranged in the non-display area (NDA). In such case, the driving controller 200 and the first and second data drivers 410, 420 may be implemented as a driver integrated circuit separated from the display panel (DP), and the driver integrated circuit may be connected to wires arranged in the non-display area (NDA). In other embodiments, the first and second scan drivers 310, 320 and the first and second ramp driver 510, 520 may be implemented as a single integrated circuit separated from the display panel (DP) together with the driving controller 200 and the first and second data drivers 410, 420.

In embodiments, the display area (DA) may have various shapes. The display area (DA) may have a shape of a closed loop including straight and/or curved sides. For example, the display area (DA) may have shapes, such as a polygon, a circle, a semicircle, an ellipse, etc.

In embodiments, the display panel (DP) may have a flat display surface. In other embodiments, the display panel (DP) may have an at least partially rounded display surface. In embodiments, the display panel (DP) may be bendable, foldable, or rollable. In such cases, the display panel (DP) and/or the substrate of the display panel (DP) may include materials having flexible properties.

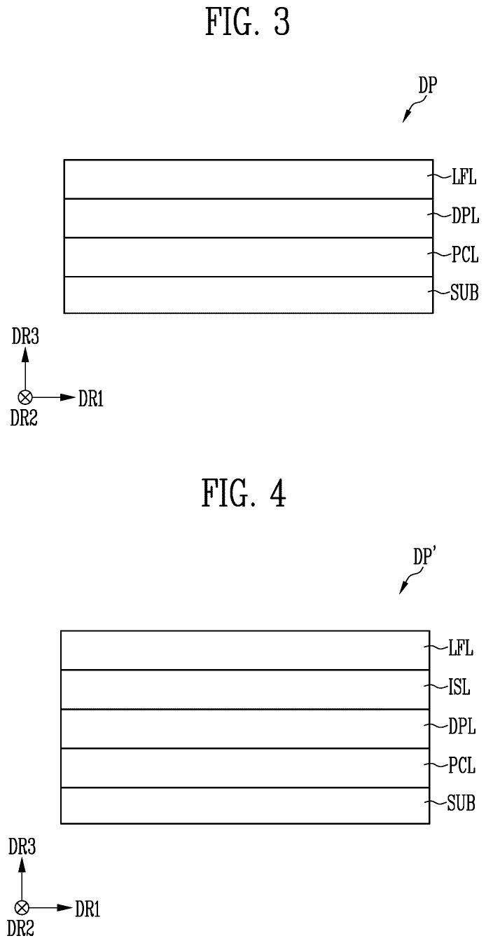

FIG. 3 is a cross-sectional diagram illustrating one or more embodiments of a display panel of FIG. 2.

Referring to FIG. 3, the display panel (DP) may include a substrate (SUB), and a pixel circuit layer (PCL), a display element layer (DPL), and a light functional layer (LFL) that are sequentially laminated in a third direction (DR3) crossing the first and second directions (DR1, DR2) on the substrate (SUB).

The substrate (SUB) may be made of an insulating material, such as glass or resin. For example, the substrate (SUB) may include a glass substrate. As another example, the substrate (SUB) may include a polyimide (PI) substrate. As another example, the substrate (SUB) may include a silicon wafer substrate formed using a semiconductor process.

In embodiments, the substrate (SUB) may be made of a flexible material such that it may be bent or folded, and may have a single-layer structure or a multi-layer structure. For example, the flexible material may include at least one of polystyrene, polyvinyl alcohol, polymethyl methacrylate, polyethersulfone, polyacrylate, polyetherimide, polyethylene naphthalate, polyethylene terephthalate, polyphenylene sulfide, polyarylate, polyimide, polycarbonate, triacetate cellulose, or cellulose acetate propionate. However, the embodiments are not limited thereto.

The pixel circuit layer (PCL) is located on the substrate (SUB). The pixel circuit layer (PCL) may include insulating layers and semiconductor patterns and conductive patterns located between the insulating layers. The conductive patterns of the pixel circuit layer (PCL) may function as circuit elements, wirings, etc.

The circuit elements of the pixel circuit layer (PCL) may include sub-pixel circuits of each of the sub-pixels (SP) of FIG. 2. In other words, the circuit elements of the pixel circuit layer (PCL) may be provided as transistors and one or more capacitors of the sub-pixel circuit (SPC).

The wirings of the pixel circuit layer (PCL) may include wirings connected to the sub-pixels (SP). The wirings of the pixel circuit layer (PCL) may include various signal lines and/or voltage lines required to drive the display element layer (DPL).

The display element layer (DPL) is located on the pixel circuit layer (PCL). The display element layer (DPL) may include light-emitting elements of the sub-pixels (SP).

The light functional layer (LFL) may be located on the display element layer (DPL). The light functional layer (LFL) may include light conversion patterns having color conversion particles and/or scattering particles. For example, the color conversion particles may include quantum dots. The quantum dots may change the wavelength (or color) of light emitted from the display element layer (DPL). The light functional layer (LFL) may further include light-scattering patterns having scattering particles. In embodiments, the light conversion patterns and the light-scattering patterns may be omitted.

The light functional layer (LFL) may further include a color filter layer including color filters. The color filter may selectively transmit light of a corresponding wavelength (or, a corresponding color). In embodiments, the color filter layer may be omitted.

A window may be provided on the light functional layer (LFL) to protect an exposed surface (or upper surface) of the display panel (DP). The window may protect the display panel (DP) from external impact. The window may be bonded to the light functional layer (LFL) through an optically transparent adhesive (or bonding) member. The window may have a multilayer structure selected from a glass substrate, a plastic film, and a plastic substrate. This multilayer structure may be formed through a continuous process or a bonding process using an adhesive layer. All or a portion of the window may be flexible.

FIG. 4 is a cross-sectional diagram illustrating one or more other embodiments of a display panel of FIG. 2.

Referring to FIG. 4, the display panel (DP′) may include a substrate (SUB), a pixel circuit layer (PCL), a display element layer (DPL), an input-sensing layer (ISL), and a light functional layer (LFL). The substrate (SUB), the pixel circuit layer (PCL), the display element layer (DPL), and the light functional layer (LFL) are configured similarly to the substrate (SUB), the pixel circuit layer (PCL), the display element layer (DPL), and the light functional layer (LFL) described with reference to FIG. 4, respectively. Hereinafter, overlapping descriptions are omitted.

The input-sensing layer (ISL) may detect a user input to the upper surface (or display surface) of the display panel (DP′). The input-sensing layer (ISL) may include configurations suitable for detecting an external object, such as a user's hand, a pen, or the like. For example, the input-sensing layer (ISL) may include touch electrodes.

FIG. 5 is a circuit diagram illustrating an example of a sub-pixel of FIG. 1.

FIG. 5 illustrates a sub-pixel (SP) of the nth pixel row and the m^{th} pixel column. Here, m n and m are positive integers.

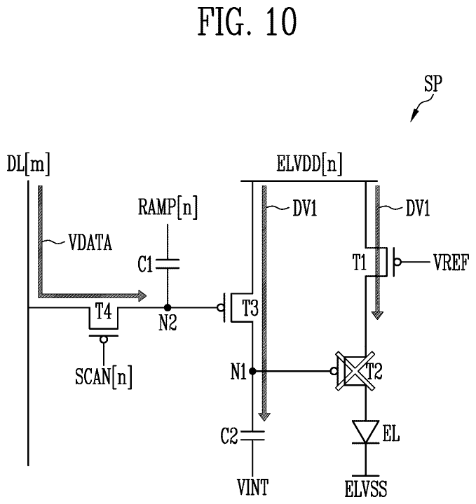

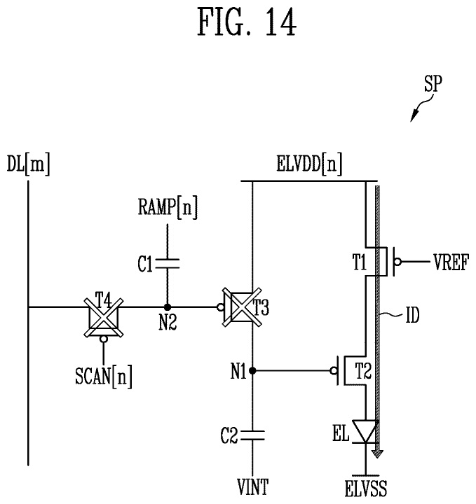

Referring to FIG. 5, a sub-pixel (SP) may include a light-emitting element (EL) that receives a driving current (ID, see FIG. 14) and that emits light, a first transistor (T1) that generates the driving current, a second transistor (T2) that transmits the driving current to the light-emitting element (EL) in response to a signal of a first node (N1), a third transistor (T3) that provides a first power voltage (ELVDD[n]) to the first node (N1) in response to a signal of a second node (N2), a fourth transistor (T4) that provides a data voltage (VDATA, see FIG. 10) to the second node (N2) in response to a scan signal (SCAN[n]), a first capacitor (C1) including a first electrode that receives a ramp signal (RAMP[n]) and a second electrode that is connected to the second node (N2), and a second capacitor (C2) including a first electrode that receives an initialization voltage (VINT) and a second electrode that is connected to the first node (N1).

For example, the first transistor (T1) may include a control electrode for receiving a reference voltage (VREF), a first electrode for receiving the first power voltage (ELVDD[n]), and a second electrode connected to the second transistor (T2). The second transistor (T2) may include a control electrode connected to the first node (N1), a first electrode connected to the first transistor (T1), and a second electrode connected to the light-emitting element (EL). The third transistor (T3) may include a control electrode connected to the second node (N2), a first electrode for receiving the first power voltage (ELVDD[n]), and a second electrode connected to the first node (N1). The fourth transistor (T4) may include a control electrode for receiving the scan signal (SCAN[n]), a first electrode connected to a data line (DL[m]), and a second electrode connected to the second node (N2). The light-emitting element (EL) may include a first electrode connected to the second transistor (T2) and a second electrode for receiving a second power voltage (ELVSS).

The transistors (T1, T2, T3, T4) may be implemented as p-channel metal oxide semiconductor (PMOS) transistors. For example, the transistors (T1, T2, T3, T4) may be P-type oxide thin film transistors.

However, the present disclosure is not limited thereto. For example, at least one of the transistors (T1, T2, T3, or T4) may be implemented as an n-channel metal oxide semiconductor (NMOS) transistor. For example, at least one of the transistors (T1, T2, T3, or T4) may be an N-type silicon thin film transistor.

The oxide thin film transistor may be a low temperature polycrystalline oxide (LTPO) thin film transistor in which an active pattern (semiconductor layer) includes oxide. However, this is exemplary, and the N-type transistors are not limited thereto. For example, the active pattern (semiconductor layer) included in the N-type transistor may include an inorganic semiconductor (e.g., amorphous silicon, poly silicon) or an organic semiconductor. The silicon thin film transistor may be a low temperature poly-silicon (LTPS) thin film transistor in which the active pattern (semiconductor layer) includes amorphous silicon, poly silicon, or the like.

In the case of an NMOS transistor, a low voltage level may be an inactivation level, and a high voltage level may be an activation level. In the case of a PMOS transistor, a low voltage level may be an activation level, and a high voltage level may be a deactivation level.

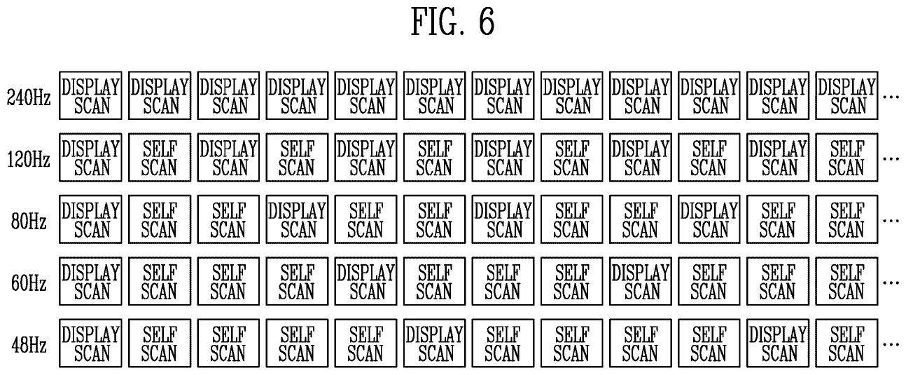

FIG. 6 is a conceptual diagram for explaining a driving operation of a display device of FIG. 1.

Referring to FIGS. 1 and 6, a display scan operation (DISPLAY SCAN) or a self-scan operation (SELF SCAN) may be performed in one frame. When the display scan operation (DISPLAY SCAN) is performed, a write operation of a data voltage (VDATA, see FIG. 10) is performed, and when the self-scan operation (SELF SCAN) is performed, a light-emitting operation may be performed without writing the data voltage.

The display scan operation (DISPLAY SCAN) of one frame is continuously repeated at the maximum driving frequency of the display panel 100 (for example, when the driving frequency is 240 Hz), and the display scan operation (DISPLAY SCAN) of one frame may be considered as one driving frame.

The display scan operation (DISPLAY SCAN) may be performed in one frame at driving frequencies (e.g., 120 Hz, 80 Hz, 60 Hz, 48 Hz) excluding the maximum driving frequency of the display panel 100 (e.g., it may be assumed that the maximum driving frequency is about 240 Hz in FIG. 6), and the self-scan operation (SELF SCAN) may be performed in at least one frame.

For example, when the driving frequency is about 120 Hz, the display scan operation (DISPLAY SCAN) of one frame and the self-scan operation (SELF SCAN) of one frame are repeated, and the display scan operation (DISPLAY SCAN) of one frame and the self-scan operation (SELF SCAN) of one frame may constitute one driving frame (e.g., the same image may be displayed during one driving frame). When the driving frequency is about 80 Hz, the display scan operation (DISPLAY SCAN) of one frame and the self-scan operation (SELF SCAN) of two frames are repeated, and the display scan operation (DISPLAY SCAN) of one frame and the self-scan operation (SELF SCAN) of two frames may constitute one driving frame. When the driving frequency is about 60 Hz, the display scan operation (DISPLAY SCAN) of one frame and the self-scan operation (SELF SCAN) of three frames are repeated, and the display scan operation (DISPLAY SCAN) of one frame and the self-scan operation (SELF SCAN) of three frames may constitute one driving frame. When the driving frequency is about 48 Hz, the display scan operation (DISPLAY SCAN) of one frame and the self-scan operation (SELF SCAN) of four frames are repeated, and the display scan operation (DISPLAY SCAN) of one frame and the self-scan operation (SELF SCAN) of four frames may constitute one driving frame.

In this way, the driving controller 200 may vary the driving frequency by adjusting the length of the self-scan period (SELF SCAN).

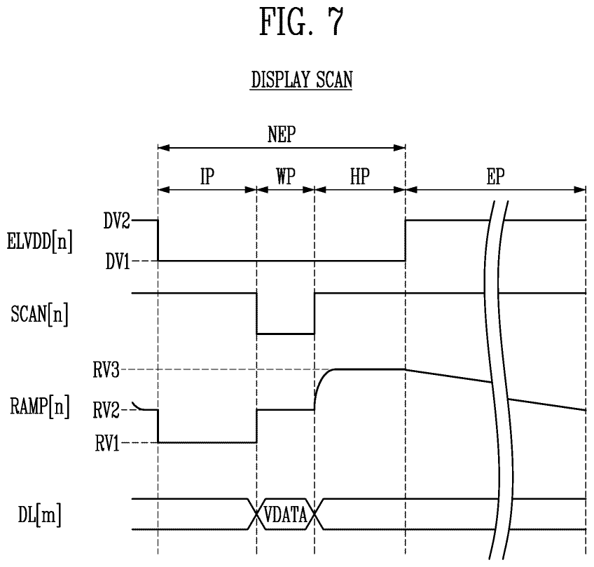

FIG. 7 is a timing diagram illustrating an example in which a display device of FIG. 1 performs a display scan operation.

Referring to FIGS. 5 and 7, the frame in which the display scan operation (DISPLAY SCAN) is performed may include a non-emitting period (NEP), and an emitting period (EP) in which a light-emitting element (EL) emits light. The non-emitting period (NEP) may include an initialization period (IP), a writing period (WP), and a holding period (HP).

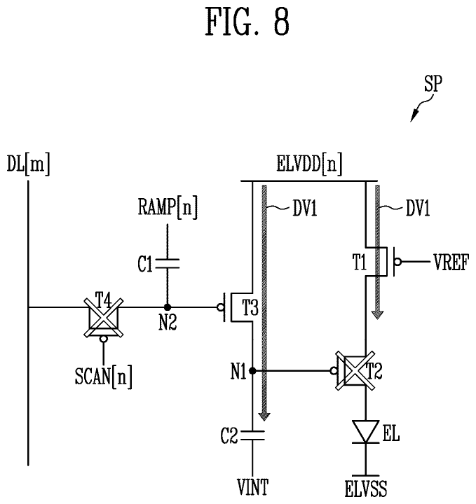

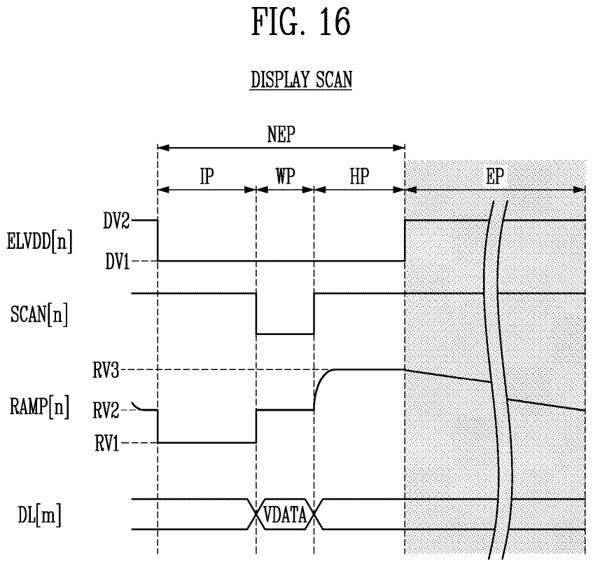

This will be described in detail below with reference to FIGS. 8 to 19.

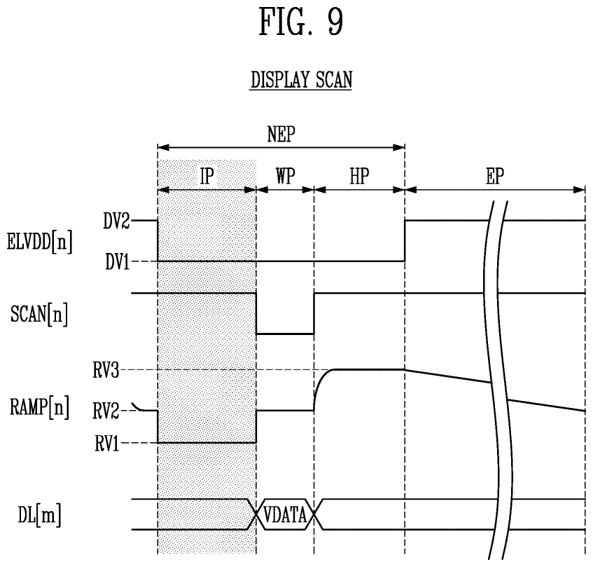

FIGS. 8 and 9 are diagrams for explaining an initialization period of FIG. 7.

Referring to FIGS. 8 and 9, in the initialization period (IP), the first power voltage (ELVDD[n]) may have a first driving voltage (DV1), the scan signal (SCAN[n]) may have an inactivation level, and the ramp signal (RAMP[n]) may be lowered to a first ramp voltage (RV1) when the initialization period (IP) starts. Accordingly, the voltage of the second node (N2) is lowered as much as the ramp signal (RAMP[n]) is lowered, and the third transistor (T3) may be turned on. Accordingly, the first power voltage (ELVDD[n]) having the first driving voltage (DV1) is applied to the first node (N1), and the second capacitor (C2) may be initialized. In addition, because the same first driving voltage (DV1) is applied to the first electrode and the control electrode of the second transistor (T2), the second transistor (T2) is turned off, and the light-emitting element (EL) may not emit light.

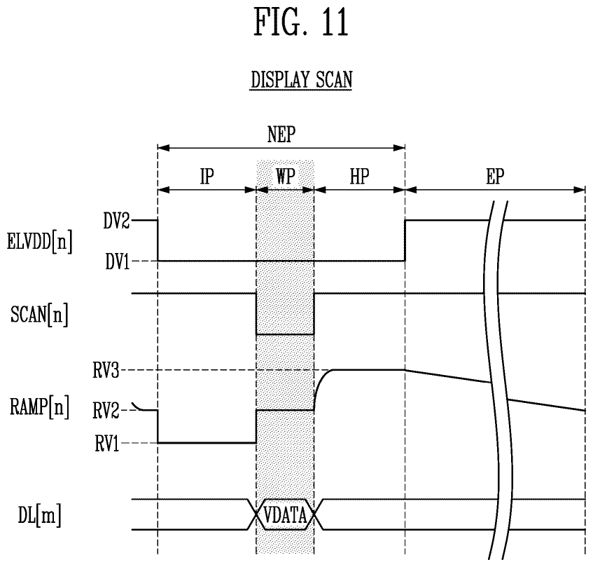

FIGS. 10 and 11 are diagrams for explaining a writing period of FIG. 7.

Referring to FIGS. 10 and 11, in the writing period (WP), the first power voltage (ELVDD[n]) may have the first driving voltage (DV1), the scan signal (SCAN[n]) may have an activation level, and the ramp signal (RAMP[n]) may have a second ramp voltage (RV2) that is higher than the first ramp voltage (RV1). Accordingly, the fourth transistor (T4) may be turned on, and the data voltage (VDATA) may be applied to the second node (N2). Accordingly, the data voltage (VDATA) may be written to the first capacitor (C1). In addition, the third transistor (T3) may be turned on, and the second transistor (T2) may be turned off.

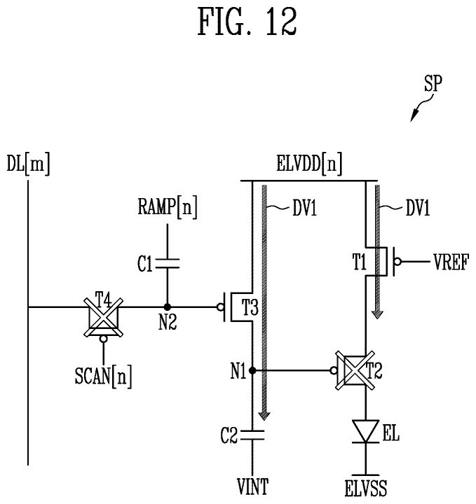

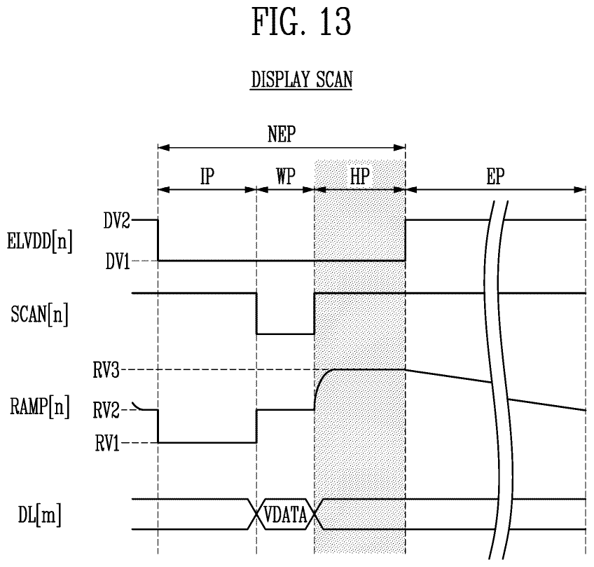

FIGS. 12 and 13 are diagrams for explaining a holding period of FIG. 7.

Referring to FIGS. 12 and 13, in the holding period (HP), the first power voltage (ELVDD[n]) may have the first driving voltage (DV1), the scan signal (SCAN[n]) may have the inactivation level, and the ramp signal (RAMP[n]) may increase from the second ramp voltage (RV2) to a third ramp voltage (RV3) that is higher than the second ramp voltage (RV2). Accordingly, the fourth transistor (T4) may be turned off, and the voltage of the second node (N2) may increase by the difference between the third ramp voltage (RV3) and the second ramp voltage (RV2). The third transistor (T3) is turned on at the beginning of the holding period (HP), but may be turned off as the voltage of the second node (N2) increases. In addition, the second transistor (T2) may be turned off.

FIGS. 14 to 16 are diagrams for explaining an emitting period of FIG. 7.

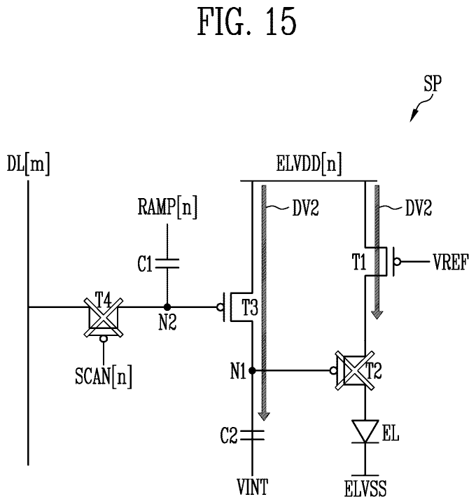

FIG. 14 illustrates that the third transistor (T3) is turned off because the voltage of the second node (N2) is not sufficiently lowered, and FIG. 15 illustrates that the third transistor (T3) is turned on because the voltage of the second node (N2) is sufficiently lowered.

Referring to FIGS. 14 to 16, in the emitting period (EP), the first power voltage (ELVDD[n]) may have a second driving voltage (DV2) that is higher than the first driving voltage (DV1), the scan signal (SCAN[n]) may have the inactivation level, and the ramp signal (RAMP[n]) may decrease. Before the voltage of the second node (N2) is sufficiently reduced, the third and fourth transistors (T3, T4) are turned off, the first transistor (T1) generates a driving current (ID) of a constant size, the second transistor (T2) is turned on, and the light-emitting element (EL) may emit light (see FIG. 14). After the voltage of the second node (N2) is sufficiently reduced, the third transistor (T3) is turned on, and the same second driving voltage (DV2) is applied to the control electrode and the first electrode of the second transistor (T2), so the second transistor (T2) is turned off, and the light-emitting element (EL) may not emit light (see FIG. 15).

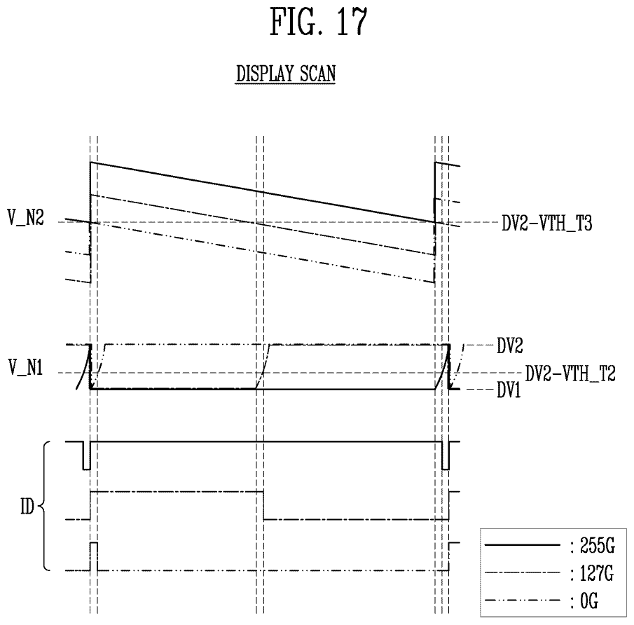

FIG. 17 is a timing diagram illustrating an example of a voltage of a first node, a voltage of a second node, and a driving current in a frame in which a display scan operation of FIG. 6 is performed. For convenience of explanation, FIG. 17 illustrates 0 grayscale (0 G), 127 grayscale (127 G), and 255 grayscale (255 G).

Referring to FIG. 5, FIG. 7, and FIG. 17, in the frame in which the display scan operation (DISPLAY SCAN) is performed, the time for which the driving current (ID) flows to the light-emitting element (EL) may vary depending on the grayscale.

The size of the data voltage (VDATA, see FIG. 10) may vary depending on the grayscale. For example, the larger the grayscale, the larger the data voltage may be. The sizes of the first power voltage (ELVDD[n]), the scan signal (SCAN[n]), and the ramp signal (RAMP[n]) may be independent of the grayscale.

For example, in the holding period (HP), the voltage (V_N2) of the second node (N2) may increase, and the third transistor (T3) may be turned off. While the third transistor (T3) is turned off in the emitting period (EP), the second transistor (T2) is turned on, and the driving current (ID) may flow to the light-emitting element (EL). In the emitting period (EP), the voltage (V_N2) of the second node (N2) decreases according to a change in the ramp signal (RAMP[n]), and when the voltage (V_N2) of the second node (N2) decreases by the difference between the second driving voltage (DV2) and a threshold voltage (VTH_T3) of the third transistor (T3), the third transistor (T3) may be turned on. When the third transistor (T3) is turned on, the voltage (V_N1) of the first node (N1) may increase to the second driving voltage (DV2). In addition, when the voltage (V_N1) of the first node (N1) increases by the difference between the second driving voltage (DV2) and a threshold voltage (VTH_T2) of the second transistor (T2), the second transistor (T2) is turned off, and the driving current (ID) may not flow to the light-emitting element (EL).

Here, the degree to which the voltage (V_N2) of the second node (N2) increases may vary depending on the grayscale. Accordingly, the time for which the driving current (ID) flows to the light-emitting element (EL) may vary depending on the grayscale. In addition, the longer the time for which the driving current (ID) flows to the light-emitting element (EL), the higher the grayscale the light-emitting element (EL) may display.

As such, the present disclosure may implement a sub-pixel (SP) driven by the PWM method with only four transistors and two capacitors. Accordingly, the resolution of the display panel 100 (see FIG. 1) may be increased. In addition, the sub-pixel (SP) may suitably display low gray levels in a sub-pixel (SP) driven by the PWM method by quickly turning off the second transistor (T2) according to the voltage change of the second node through the third transistor (T3).

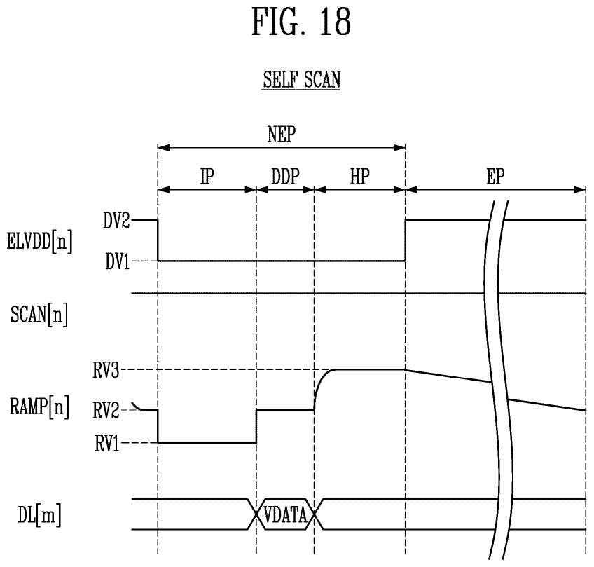

FIG. 18 is a timing diagram illustrating an example in which a display device of FIG. 1 performs a self-scan operation.

Except that the frame in which the self-scan operation (SELF SCAN) is performed includes a dummy period (DDP) instead of the writing period (WP), the self-scan operation (SELF SCAN) and the display scan operation (DISPLAY SCAN) are substantially the same, and therefore, overlapping descriptions are omitted.

Referring to FIG. 5 and FIG. 18, the frame in which the self-scan operation (SELF SCAN) is performed may include a dummy period (DDP). In the dummy period (DDP), the first power voltage (ELVDD[n]) may have the first driving voltage (DV1), the scan signal (SCAN[n]) may have the inactivation level, and the ramp signal (RAMP[n]) may have the second ramp voltage (RV2) that is higher than the first ramp voltage (RV1). Accordingly, the fourth transistor (T4) may be turned off. Accordingly, the data voltage (VDATA) may not be written in the frame in which the self-scan operation (SELF SCAN) is performed.

In FIG. 18, it is shown that the data voltage (VDATA) is applied to the data line (DL[m]), although the data voltage (VDATA) need not be applied to the data line (DL[m]) in the frame in which the self-scan operation (SELF SCAN) is performed, in one or more embodiments.

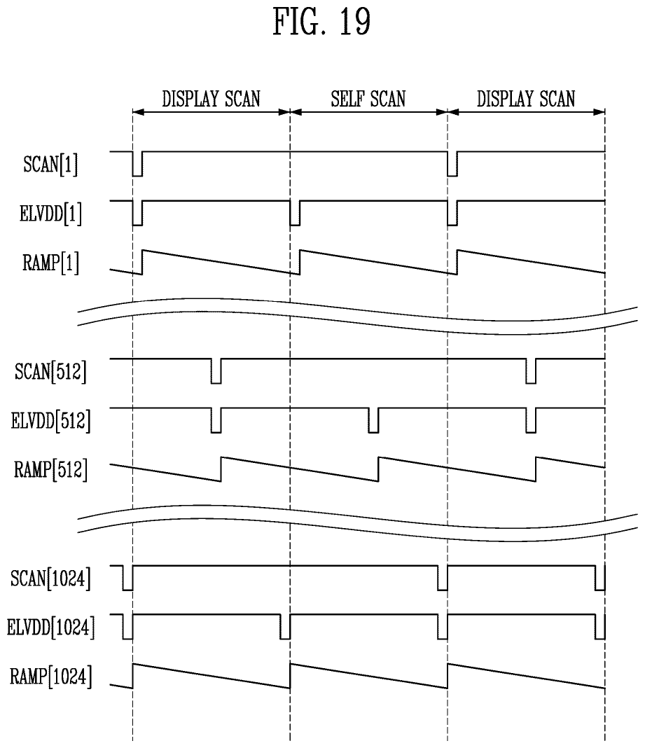

FIG. 19 is a timing diagram illustrating an example in which a display device of FIG. 1 performs a display scan operation and a self-scan operation.

For convenience of explanation, FIG. 19 shows that the driving frequency is 120 Hz (see FIG. 6).

Referring to FIG. 1 and FIG. 19, the driving controller 200 may drive the display panel 100 with a variable driving frequency. The scan signal (SCAN[n]) has a waveform of the driving frequency, and the first power voltage (ELVDD[n]) and the ramp signal (RAMP[n]) may have waveforms of the reference frequency. In other words, the waveform of the scan signal (SCAN[n]) changes according to the driving frequency, but the first power voltage (ELVDD[n]) and the ramp signal (RAMP[n]) may have constant waveforms regardless of the driving frequency.

For example, the scan signal (SCAN[n]) may not have a pulse in the frame in which the self-scan operation (SELF SCAN) is performed. For example, the first power voltage (ELVDD[n]) and the ramp signal (RAMP[n]) may have the same waveform in the frame in which the display scan operation (DISPLAY SCAN) is performed and in the frame in which the self-scan operation (SELF SCAN) is performed.

FIG. 20 is a circuit diagram illustrating a sub-pixel of a display device according to embodiments of the present disclosure.

The display device according to the present embodiments is substantially the same as the configuration of the display device described with reference to FIGS. 2 to 19 except for the configuration of the sub-pixel (SP), and therefore the same reference numbers and reference symbols are used for the same or similar components, and overlapping descriptions are omitted.

FIG. 20 illustrates the sub-pixel (SP) of the nth pixel row and the m^{th} pixel column. Here, n and m are positive integers.

Referring to FIG. 20, the sub-pixel (SP) may include a light-emitting element (EL) that receives a driving current (ID, see FIG. 14) and that emits light, a first transistor (T1) that generates the driving current, a second transistor (T2) that transmits a second power voltage (ELVSS[n]) to the light-emitting element (EL) in response to a signal of a first node (N1), a third transistor (T3) that provides the second power voltage (ELVSS[n]) to the first node (N1) in response to a signal of a second node (N2), a fourth transistor (T4) that provides a data voltage (VDATA, see FIG. 10) to the second node (N2) in response to a scan signal (SCAN[n]), a first capacitor (C1) including a first electrode that receives a ramp signal (RAMP[n]) and a second electrode that is connected to the second node (N2), and a second capacitor (C2) including a first electrode that receives an initialization voltage (VINT) and a second electrode that is connected to the first node (N1).

For example, the first transistor (T1) may include a control electrode for receiving a reference voltage (VREF), a first electrode connected to the light-emitting element (EL), and a second electrode connected to the second transistor (T2). The second transistor (T2) may include a control electrode connected to the first node (N1), a first electrode connected to the first transistor (T1), and a second electrode for receiving the second power voltage (ELVSS[n]). The third transistor (T3) may include a control electrode connected to the second node (N2), a first electrode for receiving the second power voltage (ELVSS[n]), and a second electrode connected to the first node (N1). The fourth transistor (T4) may include a control electrode for receiving the scan signal (SCAN[n]), a first electrode connected to a data line (DL[m]), and a second electrode connected to the second node (N2). The light-emitting element (EL) may include a first electrode connected to the first transistor (T1) and a second electrode for receiving a first power voltage (ELVDD). Here, unlike in FIG. 5, the first power voltage (ELVDD) may have the same voltage for all sub-pixels (SP).

The transistors (T1, T2, T3, T4) may be implemented as NMOS transistors. For example, the transistors (T1, T2, T3, T4) may be N-type oxide thin film transistors.

However, the present disclosure is not limited thereto. For example, at least one of the transistors (T1, T2, T3, or T4) may be implemented as a PMOS transistor. For example, at least one of the transistors (T1, T2, T3, or T4) may be a P-type silicon thin film transistor.

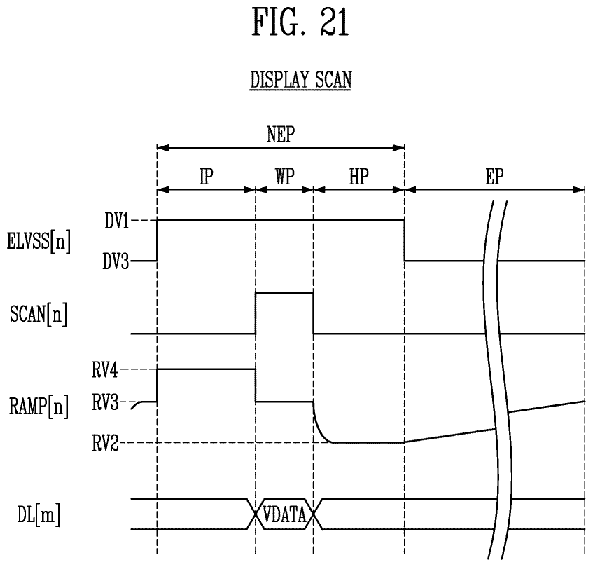

FIG. 21 is a timing diagram illustrating an example in which a display device of FIG. 20 performs a display scan operation.

Referring to FIGS. 20 and 21, the frame in which the display scan operation (DISPLAY SCAN) is performed may include a non-emitting period (NEP) and an emitting period (EP) in which the light-emitting element (EL) emits light. The non-emitting period (NEP) may include an initialization period (IP), a writing period (WP), and a holding period (HP).

In the initialization period (IP), the second power voltage (ELVSS[n]) may have a first driving voltage (DV1), the scan signal (SCAN[n]) may have an inactivation level, and the ramp signal (RAMP[n]) may increase to a fourth ramp voltage (RV4) when the initialization period (IP) starts. Accordingly, the voltage of the second node (N2) increases as much as the ramp signal (RAMP[n]) increases, and the third transistor (T3) may be turned on. Accordingly, the second power voltage (ELVSS[n]) having the first driving voltage (DV1) may be applied to the first node (N1), and the second capacitor (C2) may be initialized. In addition, because the same first driving voltage (DV1) is applied to the second electrode and the control electrode of the second transistor (T2), the second transistor (T2) may be turned off, and the light-emitting element (EL) may not emit light.

In the writing period (WP), the second power voltage (ELVSS[n]) may have the first driving voltage (DV1), the scan signal (SCAN[n]) may have an activation level, and the ramp signal (RAMP[n]) may have a third ramp voltage (RV3) that is lower than the fourth ramp voltage (RV4). Accordingly, the fourth transistor (T4) may be turned on, and the data voltage (VDATA) may be applied to the second node (N2). Accordingly, the data voltage (VDATA) may be written to the first capacitor (C1). Then, the third transistor (T3) may be turned on, and the second transistor (T2) may be turned off.

In the holding period (HP), the second power voltage (ELVSS[n]) may have the first driving voltage (DV1), the scan signal (SCAN[n]) may have the inactivation level, and the ramp signal (RAMP[n]) may decrease from the third ramp voltage (RV3) to a second ramp voltage (RV2) that is lower than the third ramp voltage (RV3). Accordingly, the fourth transistor (T4) may be turned off, and the voltage of the second node (N2) may be decreased by the difference between the third ramp voltage (RV3) and the second ramp voltage (RV2). The third transistor (T3) may be turned on at the beginning of the holding period (HP), but may be turned off as the voltage of the second node (N2) decreases. In addition, the second transistor (T2) may be turned off.

In the emitting period (EP), the second power voltage (ELVSS[n]) may have a third driving voltage (DV3) that is lower than the first driving voltage (DV1), the scan signal (SCAN[n]) may have the inactivation level, and the ramp signal (RAMP[n]) may increase. Before the voltage of the second node (N2) sufficiently increases, the third and fourth transistors (T3, T4) are turned off, the first transistor (T1) generates a driving current (ID) of a constant size, the second transistor (T2) is turned on, and the light-emitting element (EL) may emit light. After the voltage of the second node (N2) is sufficiently increased, the fourth transistor (T4) is turned on, and the same third driving voltage (DV3) is applied to the control electrode and the second electrode of the second transistor (T2), so the second transistor (T2) is turned off, and the light-emitting element (EL) may not emit light.

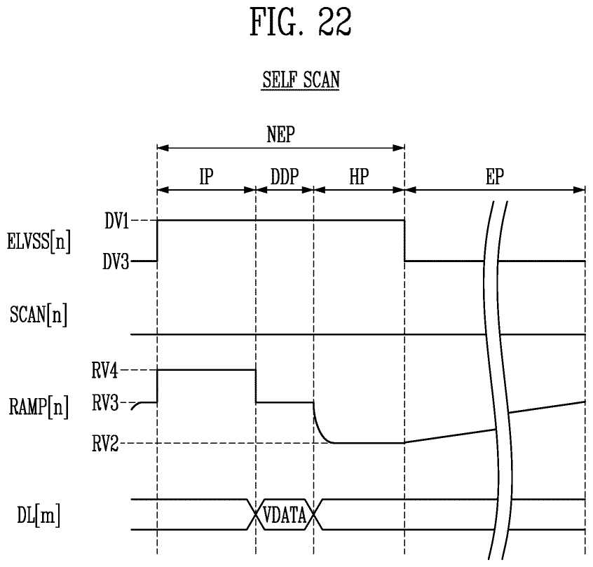

FIG. 22 is a timing diagram illustrating an example in which a display device of FIG. 20 performs a self-scan operation.

Except that the frame in which the self-scan operation (SELF SCAN) is performed includes a dummy period (DDP) instead of a writing period (WP), the self-scan operation (SELF SCAN) and the display scan operation (DISPLAY SCAN) are substantially the same, and therefore, overlapping description is omitted.

Referring to FIGS. 20 and 22, the frame in which the self-scan operation (SELF SCAN) is performed may include a dummy period (DDP). In the dummy period (DDP), the second power voltage (ELVSS[n]) may have the first driving voltage (DV1), the scan signal (SCAN[n]) may have the inactivation level, and the ramp signal (RAMP[n]) may have the third ramp voltage (RV3) that is lower than the fourth ramp voltage (RV4). Accordingly, the fourth transistor (T4) may be turned off. Therefore, the data voltage (VDATA) may not be written in the frame in which the self-scan operation (SELF SCAN) is performed.

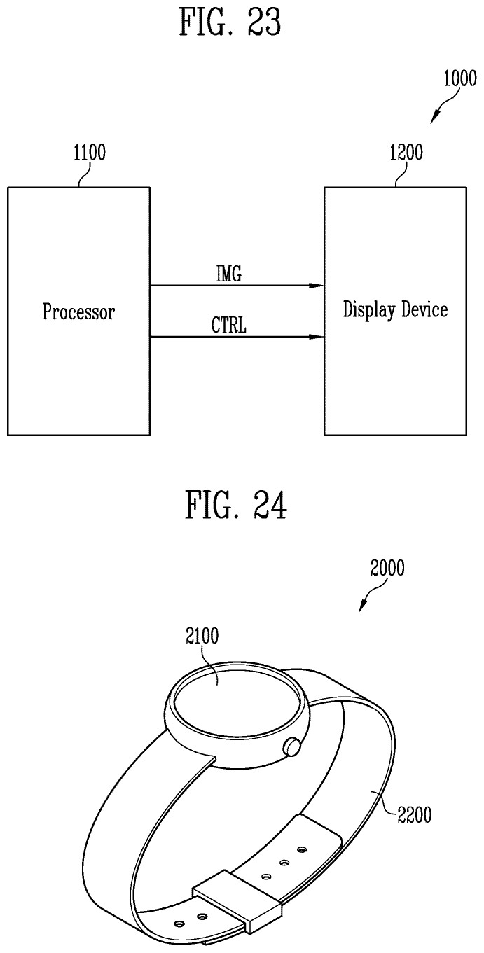

FIG. 23 is a block diagram illustrating one or more embodiments of a display system.

Referring to FIG. 23, the display system 1000 may include a processor 1100 and a display device 1200.

The processor 1100 may perform various tasks and calculations. In embodiments, the processor 1100 may include an application processor, a graphic processor, a microprocessor, a central processing unit (CPU), etc. The processor 1100 may be connected to other components of the display system 1000 through a bus system and control them.

The processor 1100 may transmit image data (IMG) and a control signal (CTRL) to the display device 1200. The display device 1200 may display an image based on the image data (IMG) and the control signal (CTRL). The display device 1200 may be configured similarly to the display device (DD) described with reference to FIG. 1. In this case, the image data (IMG) and the control signal (CTRL) may be provided as the input image data (IMG) and the control signal (CTRL) of FIG. 1, respectively.

The display system 1000 may include a computing system that provides an image display function, such as a smart watch, a mobile phone, a smart phone, a portable computer, a tablet personal computer (PC), a watch phone, an automotive display, smart glasses, a portable multimedia player (PMP), a navigation system, an ultra-mobile personal computer (UMPC), and the like. In addition, the display system 1000 may include at least one of a head mounted display (HMD), a virtual reality (VR) device, a mixed reality (MR) device, or an augmented reality (AR) device.

FIGS. 24 to 27 are perspective views illustrating application examples of a display system of FIG. 23.

Referring to FIG. 24, the display system 1000 of FIG. 23 may be applied to a smart watch 2000 including a display part 2100 and a strap part 2200.

The smart watch 2000 may be a wearable electronic device. For example, the smart watch 2000 may have a structure in which the strap part 2200 is worn on a user's wrist. Here, the display part 2100 may be applied with the display system 1000 and/or the display device 1200, so that image data including time information may be provided to the user.

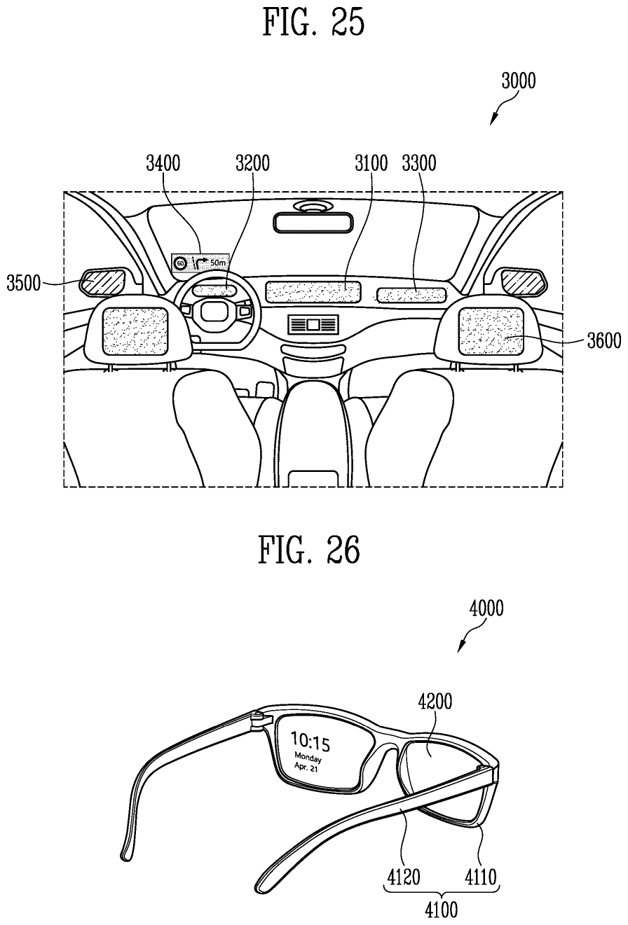

Referring to FIG. 25, the display system 1000 of FIG. 23 may be applied to an automotive display system 3000. Here, the automotive display system 3000 may include a computing system that is installed inside and/or outside a vehicle and provides image data.

For example, the display system 1000 and/or the display device 1200 may be applied to at least one of an infotainment panel 3100, a cluster 3200, a co-driver display 3300, a head-up display 3400, a side mirror display 3500, or a rear seat display 3600 provided in a vehicle.

Referring to FIG. 26, the display system 1000 of FIG. 23 may be applied to smart glasses 4000. The smart glasses 4000 may be a wearable electronic device that may be worn on a user's head. For example, the smart glasses 4000 may be a wearable device for augmented reality.

The smart glasses 4000 may include a frame 4100 and a lens part 4200. The frame 4100 may include a housing 4110 that supports the lens part 4200 and a leg part 4120 for wearing by a user. The leg part 4120 is connected to the housing 4110 through a hinge and may be folded or unfolded with respect to the housing 4110.

A battery, a touch pad, a microphone, a camera, and the like may be built into the frame 4100. In addition, a projector that outputs light, a processor that controls an optical signal, and the like may be built into the frame 4100.

The lens part 4200 may include an optical member that transmits light or reflects light. For example, the lens part 4200 may include glass, a transparent synthetic resin, and the like.

In order for the user's eyes to recognize visual information, the lens part

4200 may reflect an image by an optical signal transmitted from the projector of the frame 4100 to the rear surface of the lens part 4200 (for example, a surface facing the user's eyes). For example, the user may recognize visual information, such as time and date displayed on the lens part 4200. At this time, the projector and/or the lens part 4200 may be a type of display device. The display device 1200 may be applied to the projector and/or the lens part 4200.

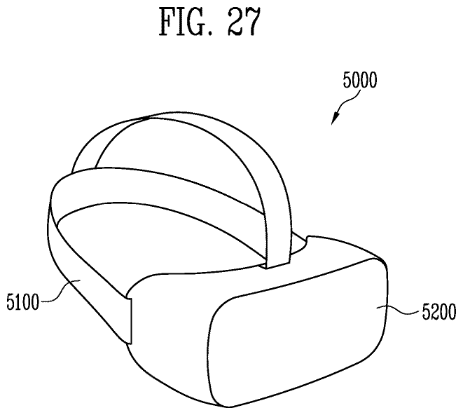

Referring to FIG. 27, the display system 1000 of FIG. 23 may be applied to a head-mounted display device 5000.

The head-mounted display device 5000 may be a wearable electronic device that may be worn on the user's head. For example, the head-mounted display device 5000 may be a wearable device for virtual reality or mixed reality.

The head-mounted display device 5000 may include a head-mounted band 5100 and a display device storage case 5200. The head-mounted band 5100 may be connected to the display device storage case 5200. The head-mounted band 5100 may include a horizontal band and/or a vertical band for securing the head-mounted display device 5000 to a user's head. The horizontal band may be configured to surround a side of the user's head, and the vertical band may be configured to surround an upper portion of the user's head. However, embodiments are not limited thereto. For example, the head-mounted band 5100 may be implemented in a form of a glasses frame, a helmet, or the like.

The display device storage case 5200 may store the display system 1000 and/or the display device 1200.

Although embodiments and application examples have been described herein, they are provided only to help a more general understanding of the present disclosure, and the present disclosure is not limited to the above embodiments, and various modifications and variations are possible from this description by those skilled in the art to which the present disclosure pertains. Therefore, the spirit of this disclosure should not be limited to the described embodiments, and not only the claims described below, but also all those with modifications equal to or equivalent to the claims will fall within the scope of the present disclosure.

The present disclosure may be applied to display devices and electronic devices including the same. For example, the present disclosure may be applied to digital TVs, 3D TVs, mobile phones, smart phones, tablet computers, VR devices, PCs, home electronic devices, notebook computers, PDAs, PMPs, digital cameras, music players, portable game consoles, navigation systems, etc.

The present disclosure may implement a sub-pixel driven by a PWM method with a small number of transistors and a small number of capacitors. Accordingly, the resolution of a display panel may be increased.

The sub-pixel according to the embodiments of the present disclosure may suitably display low gray levels by quickly turning off the second transistor according to the voltage change of the second node through the third transistor.

However, aspects of the present disclosure are not limited to the above-described aspects, and may be variously expanded without departing from the spirit and scope of the present disclosure.

Although the present disclosure has been described with reference to the above embodiments, it will be understood by those skilled in the art that various modifications and variations may be made to the present disclosure without departing from the spirit and scope of the present disclosure as set forth in the appended claims, with functional equivalents thereof to be included therein.

What is claimed is:

1. A sub-pixel comprising:
a light-emitting element configured to receive a driving current, and to emit light;
a first transistor configured to generate the driving current;
a second transistor configured to transmit the driving current to the light-emitting element in response to a signal from a first node;
a third transistor configured to provide a first power voltage to the first node in response to a signal from a second node;
a fourth transistor configured to provide a data voltage to the second node in response to a scan signal; and
a first capacitor comprising a first electrode for receiving a ramp signal, and a second electrode connected to the second node.

2. The sub-pixel according to claim 1, further comprising a second capacitor comprising a first electrode for receiving an initialization voltage, and a second electrode connected to the first node.

3. The sub-pixel according to claim 2, wherein the first power voltage has a first driving voltage in a non-emitting period of one frame, and a second driving voltage that is higher than the first driving voltage in an emitting period of the one frame.

4. The sub-pixel according to claim 3, wherein the non-emitting period comprises an initialization period in which the second capacitor is initialized, and a writing period in which the data voltage is written to the first capacitor.

5. The sub-pixel according to claim 4, wherein the scan signal has an activation level in the writing period.

6. The sub-pixel according to claim 4, wherein the ramp signal is lowered to a first ramp voltage when the initialization period starts.

7. The sub-pixel according to claim 6, wherein the ramp signal has a second ramp voltage that is higher than the first ramp voltage in the writing period.

8. The sub-pixel according to claim 7, wherein the non-emitting period further comprises a holding period in which the ramp signal increases from the second ramp voltage to a third ramp voltage that is higher than the second ramp voltage.

9. The sub-pixel according to claim 8, wherein the ramp signal decreases in the emitting period.

10. The sub-pixel according to claim 1, wherein the scan signal has a waveform of a driving frequency, and
wherein the first power voltage and the ramp signal have a waveform of a reference frequency.

11. A sub-pixel comprising:
a light-emitting element configured to receive a driving current, and to emit light;
a first transistor configured to generate the driving current;
a second transistor configured to transmit a second power voltage to the first transistor in response to a signal from a first node;
a third transistor configured to provide the second power voltage to the first node in response to a signal from a second node;
a fourth transistor configured to provide a data voltage to the second node in response to a scan signal; and
a first capacitor comprising a first electrode for receiving a ramp signal, and a second electrode connected to the second node.

12. The sub-pixel according to claim 11, further comprising a second capacitor comprising a first electrode for receiving an initialization voltage, and a second electrode connected to the first node.

13. The sub-pixel according to claim 12, wherein the second power voltage has a first driving voltage in a non-emitting period of one frame, and a third driving voltage that is lower than the first driving voltage in an emitting period of the one frame.

14. The sub-pixel according to claim 13, wherein the non-emitting period comprises an initialization period in which the second capacitor is initialized, and a writing period in which the data voltage is written to the first capacitor.

15. The sub-pixel according to claim 14, wherein the scan signal has an activation level in the writing period.

16. The sub-pixel according to claim 14, wherein the ramp signal is raised to a fourth ramp voltage when the initialization period starts.

17. The sub-pixel according to claim 16, wherein the ramp signal has a third ramp voltage that is lower than the fourth ramp voltage in the writing period.

18. The sub-pixel according to claim 17, wherein the non-emitting period further comprises a holding period in which the ramp signal is lowered from the third ramp voltage to a second ramp voltage that is lower than the third ramp voltage.

19. The sub-pixel according to claim 18, wherein the ramp signal increases in the emitting period.

20. An electronic device comprising a display device comprising:
a display panel comprising a sub-pixel; and
a display panel driver configured to drive the display panel,
wherein the sub-pixel comprises:
a light-emitting element configured to receive a driving current, and to emit light;
a first transistor configured to generate the driving current;
a second transistor configured to transmit the driving current to the light-emitting element in response to a signal from a first node;
a third transistor configured to provide a first power voltage to the first node in response to a signal from a second node;
a fourth transistor configured to provide a data voltage to the second node in response to a scan signal; and
a first capacitor comprising a first electrode for receiving a ramp signal, and a second electrode connected to the second node.
